(19) United States
(12) Patent Application Publication
(10) Pub. No.: US 2007/0293100 A1
(43) Pub. Date: Dec. 20, 2007

(54) Pin For The Soldering-Free Electric Connection To A Printed Circuit Board, A Pressing-In Tool, In Addition To A Method For The Production Of A Soldering-Free Electric Connection

(76) Inventors: Gert Jakob, Stuttgart (DE); Bernd Eckert, Vaihingen (DE)

Correspondence Address: MICHAEL J. STRIKER, 103 EAST NECK ROAD, HUNTINGTON, NY, 11743, US

(21) Appl. No.: 11/587,238

(22) PCT Filed: Apr. 26, 2005
(86) PCT No.: PCT/EP05/51869

§ 371 Date: Jun. 12, 2007

(30) Foreign Application Priority Data
Apr. 27, 2004 (DE) 10 2004 020 422.5

(51) Int. Cl. H01R 4/48

(52) U.S. Cl. 439/816; 29/747; 81/488

(57) ABSTRACT

The invention relates to a pin (10) which can be electrically connected in a soldering-free manner to a printed circuit board, said pin comprising a punching sheet profile provided with a contact pin section (11) for a plug connector and/or a plug connector strip, a first securing section (12) for the plug connector and/or the plug connector strip, a connection section (13) and a second securing section (15) provided with a pressing-in area (16), which can be at least elastically shaped in a printed circuit board hole such that it can be adapted to the diameter of the hole. The pin (10) comprises a bearing profile (14, 18, 19) which is arranged in the punching plane and which is used for a pressing-in tool (24) and is angled away from the punching plane in a connecting section (13) thereof. An insertable and removable, after having been inserted, pressing-in tool is provided for the insertion of at least one pin

### BACKGROUND INFORMATION

The present invention relates to a pin for the soldering-free, electric connection with a printed circuit board, a pressing-in tool for the insertion of at least one such pin into a printed circuit board, and a method for manufacturing a soldering-free, electric connection of a pin with a printed circuit board using this pressing-in tool.

Pins of this type are used, e.g., in large numbers in plug connector strips for electronic control units, which are used in motor vehicles; the pins were either soldered or pressed into the related printed circuit board. To create a soldering-free, electric connection with a metallized hole in the printed circuit board when the pins are pressed in, the pins include a special elastic press-in zone, which is deformed plastically and elastically when it is pressed into the hole in the printed circuit board and adapts to the diameter of the hole.

The dimensional stability of the pins - which are either wire-drawn or punched out of a flat strip, due to the tip geometry on the insertion side - is limited. Installation aids have therefore been used for insertion, which are placed in position as a separate part when plug connector strips are assembled, and which remain in the unit after the plug connector strip is assembled. In addition, there are special designs of plug connector strips with straight or fully embedded, right-angled pins, with which a plastic housing formed directly on the plug connector strips via injection moulding is always used. Since plug connector strips include up to approximately 100 pins, there is a risk that, since the elastic regions of the exposed pin shafts between the insulating body of the plug connector strip and the contact point in the printed circuit board are short, a tight mechanical coupling will occur which, due to the bimetal effect of the different thermal expansion coefficients, results in a high mechanical load on the pressed-in contact points. To eliminate this disadvantage, complex measures have been required, which increase the fabrication cost and effort and limit the amount of freedom available to design the plug connector strip.

Publication U.S. Pat. No. 6,106,308 A makes known a pin of the type mentioned initially, which is composed of a punched, twice-right-angled element, which includes a right-angled, open socket connector in the region of a plug connector and, in the application region, it includes a shoulder which extends out of the punching plane in the shape of an S. Although the multiple bends in the connection section of the pin in the punching plane improve the stiffness in the punching plane, the stiffness perpendicular thereto is still inadequate. For this reason, the sacrificed installation aids mentioned previously—the disadvantages of which were described above—are also required in this case.

The present invention is based on the object of providing a pin, a pressing-in tool, and a method of the type mentioned initially, which make it possible to manufacture plug connector strips with different configurations without sacrificing installation aids, and with a high level of production quality.

According to the present invention, this object is attained using a pin with the features named in claim 1. Further configurations of this pin are described in claims 2 through 5.

This object is also attained by using a pressing-in tool for inserting at least one pin as recited in claim 6, and by using a method for creating a soldering-free, electric connection of a pin to a printed circuit board as recited in claim 8.

A preferred further embodiment of the pressing-in tool is described in claim 7.

### ADVANTAGES OF THE INVENTION

Due to the inventive configuration of the pin, the pressing-in tool, and the method, plug connector strips can be advantageously manufactured with improved production quality. The large elastic regions in the connection section of the pins result in a mechanical decoupling between an insulating body and the printed circuit board, with the result that large plug connector strips with more than ten pins can also be realized without limitations. The design can be realized with a right-angled plug connector strip just as flexibly as when the soldering technique is used and, by using the pressing-in technique, the “taboo” zones are advantageously reduced as compared with the known selective soldering method.

Advantageously, the regions that do not contain the sacrificed installation aids compensate for different thermal expansion coefficients resulting from the mechanical decoupling between the insulating body and/or plug connector strip and the printed circuit board, and for the motions of the plug connector strips relative to the plug connector strips.

The inventive pressing-in tool, which is provided for inserting and pressing in a pin, and, when the pins are arranged in groups, for inserting and pressing in groups of pins, advantageously guides the right-angled pins during installation without the need for additional installation aids which are sacrificed, such as pull-through plates.

The inventive pins can be manufactured extraordinarily easily out of a single punched part after a single turn around an axis in the punched plane without any further deformation of the securing section and the bearing profile before they are pressed in. By arranging such pins in several groups, a high amount of flexibility in the manufacture of plug connector strips can be advantageously attained, and reduced component assembly is also advantageously possible without limitations.

It is also favorable that, with the pins, the pressing-in tool, and the method, an automated, monitored assembly of plug connector strips is made possible in a cost-effective manner and with a high level of process reliability.

### DRAWING

The present invention is explained below with reference to the attached drawing.

FIG. 1 shows a perspective view of an exemplary embodiment of a right-angled pin;

FIG. 2 shows a front view of the pin in FIG. 1;

FIG. 3 shows a section of a row of pins in FIG. 1 with an installed, partially-exposed pressing-in tool before they are pressed into a printed circuit board; and

FIG. 4 shows a view similar to FIG. 3 after the pins are pressed in and before the pressing-in tool is removed.

### DESCRIPTION OF THE EXEMPLARY EMBODIMENTS

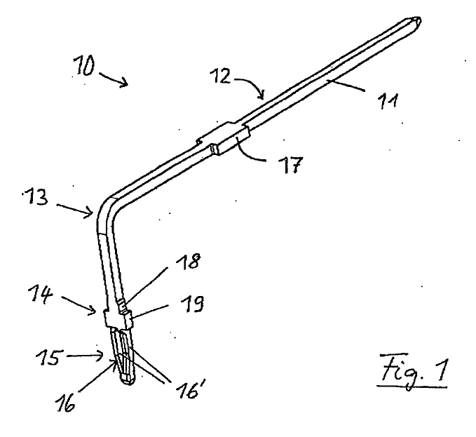

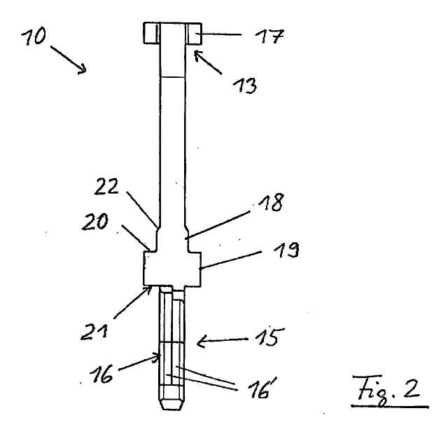

A perspective view of a right-angled pin 10 is shown in FIG. 1, and a front/top view of the section with the press-in end is shown in FIG. 2. Pin 10 is provided for a soldering-free, electric connection with a not-shown printed circuit board. Pins of this type are typically provided in numbers of ten or more in one or more rows for placement in a plug connector strip, which is electrically connected via the pins with assigned conductive points on a printed circuit board.

Inventive pin 10 is composed of a right-angled, punched sheet profile and includes a contact pin section 11, a first securing section 12 for securing pin 10 in a not-shown plug connector or plug connector strip, a connection section 13, which is angled by preferably 900 around an axis which lies in the punching plane and extends to a bearing profile 14, and a second securing section 15 with a pressing-in region 16 with deformable legs 16′, which are at least elastically and, optionally, plastically deformable for pressing into a hole in a printed circuit board (not shown in FIGS. 1 and 2), so they can adapt to the diameter of the hole in the printed circuit board. Pin 10 can also have multiple bends, e.g., 2 x 450 or other angles.

Pin 10, which is composed of a punched sheet profile, has a bearing and securing profile 17 in its first securing section 12, which extends toward both sides of pin 10 in the punching plane. After pin 10 is punched and before connection section 13 is bent, bearing profile 14 is also located in the punching plane and transitions—on both sides of pin 10, via a conical transition section 22—into an expanded section 18, which extends in a stepped manner on both sides into a wider bearing section 19. As described in greater detail below, bearing section 19 is provided for placement of a pressing-in tool, which is removed after pin 10 is pressed in.

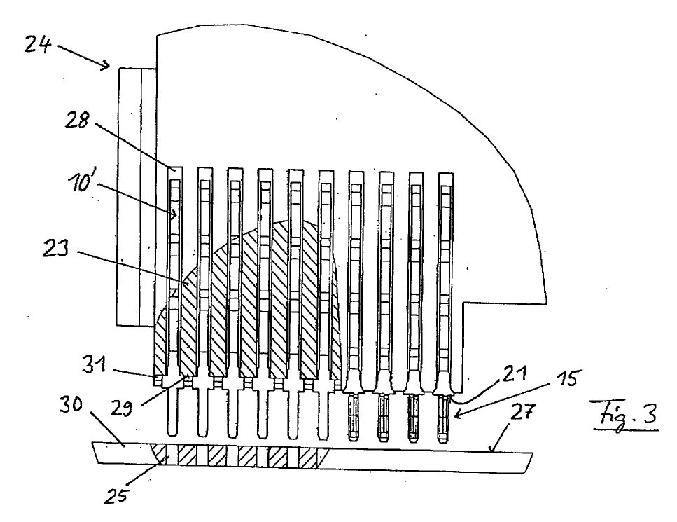

As an example, FIG. 3 shows several pins 10′ with extended shafts positioned in a row. A pressing-in tool 24 is placed above the right-angled section of pins 10 with slight play for guidance and reinforcement, and it rests with its lower end 29 on bearing profile 19 with a slight overhang, as shown in the partially-exposed view. To this end, bearing section 19 includes a bearing shoulder 20, as shown clearly in FIG. 2. A contact section 21 is formed on its underside, with which pin 10 bears against the surface of a printed circuit board 20 after it is pressed in.

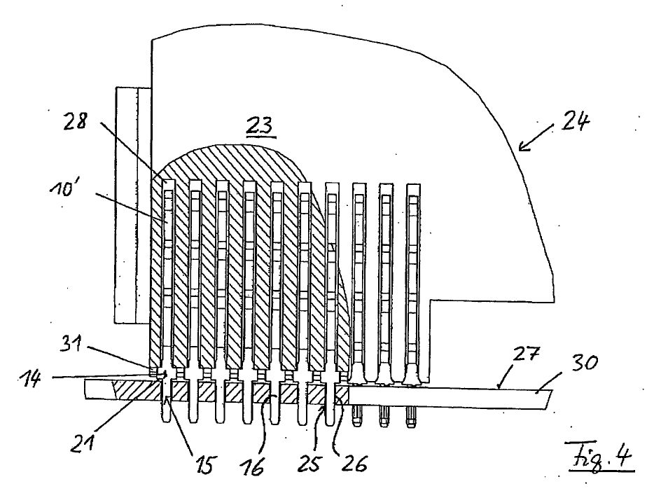

A portion of a row of pins with pressing-in tool 24 placed on top is shown schematically in FIGS. 3 and 4 before insertion into holes 25 of printed circuit board 30 and after having been pressed into these holes 25, respectively. Press-in region 16 of second securing section 15—which has been elastically and plastically deformed—is connected fixedly and in an electrically conductive manner with an electrically conductive inner lining of the hole. After pressing-in, contact section 21 of each pin 10 rests on surface 27 of printed circuit board 30. As shown in FIG. 4, it can also be located a defined distance away, however.

Pressing-in tool 24 is composed of a dimensionally stable guiding and reinforcing body 23 which can be placed on particular pin 10. As shown in FIGS. 3 and 4, guiding and reinforcing body 23 includes recesses 28 which match the shape of pins 10 and which are open toward the back—perpendicularly to the drawing plane of FIGS. 3 and 4—for placement of press-in tool 24 and for removal after pressing-in is completed.

As shown in FIGS. 3 and 4, dimensionally stable guiding and reinforcing body 23 includes, on its underside, a section 29 for acting on bearing shoulder 20 of bearing section 19 of bearing profile 14. Section 29 is formed in the underside of press-in tool 24 in the form of a groove 31, which is slightly wider than the thickness of pin 10.

To remove press-in tool 24, it is lifted upward far enough that the pin shafts and/or bearing profile 14 of pins 10 are exposed, then the press-in tool is removed upwardly out of the picture plane of FIGS. 3 and 4.

Press-in tool 24 is dimensionally stable and can also be provided with a matrix of integrally formed pin receptacles 28, which are positioned in several planes, one behind the other, and which are offset. Dimensionally stable guiding and reinforcing body 23, with bearing profile 31, ensures that pin 10 is guided and reinforced reliably when it is pressed in.

1. Pin (10) for the soldering-free, electric connection with a printed circuit board (30), composed of a punched sheet profile with a contact pin section (11) for a plug connector and/or a plug connector strip;
a first securing section (12) for the plug connector and/or plug connector strip;
a connection section (13) and,
a second securing section (15) with a pressing-in area (16), which can be at least elastically shaped in a hole (25) of the printed circuit board (30); the pin (10) has a bearing profile (14, 18, 19) in the punching plane for a pressing-in tool (24) and is right-angled relative to the punching plane in its connecting section (13).

2. The pin as recited in claim 1,
wherein
the bearing profile (14) has an expanded section (18) and a bearing section (19).

3. The pin as recited in claim 2,
wherein
the bearing section (19) extends outwardly, perpendicular to the pin (10).

4. The pin as recited in one of the preceding claims,
wherein
the bearing profile (14) has a contact section (21), which serves as a stop for the pin (10) when it is pressed into the printed circuit board (30).

5. The pin as recited in one of the preceding claims,
wherein
the bearing profile (14) is located in the region between the connecting section (13) and the second securing section (15).

6. A pressing-in tool for inserting at least one pin (10), as recited in one of the preceding claims, into a printed circuit board (30), the pressing-in tool being composed of a dimensionally stable guiding and reinforcing body (23) which is placeable on the particular pin (10); the guiding and reinforcing body (23) includes a section (29) which contacts the bearing profile (14) of the pin (10) and, after it is pressed into the printed circuit board (30) of the at least one pin(10), it can be removed.

7. The pressing-in tool as recited in claim 6,
wherein
the contact section (22) is formed on the end of the guiding and reinforcing body (23) with a slight overhang.

8. The method for manufacturing a soldering-free, electric connection of a pin (10), as recited in claim 1, to a printed circuit board (30),
wherein
each pin (10) is initially reinforced in accordance with its shape using a dimensionally stable pressing-in tool (24) and is subsequently acted upon on its bearing profile (14) using the pressing-in tool (24) for insertion into an assigned hole (25) in the printed circuit board (30), after which the pressing-in tool (24) is removed from the pressed-in pin (10).
